(19) United States
(12) Patent Application Publication
(10) Pub. No.: US 2024/0248035 A1
(43) Pub. Date: Jul. 25, 2024

(54) A METHOD AND A SYSTEM FOR DETERMINING A PROPERTY OF AT LEAST ONE LIQUID

(71) Applicant: FIDA BIOSYSTEMS APS, Søborg (DK)

(72) Inventor: Henrik JENSEN, Søborg (DK)

(73) Assignee: FIDA BIOSYSTEMS APS, Søborg (DK)

(21) Appl. No.: 18/289,957

(22) PCT Filed: May 11, 2022
(86) PCT No.: PCT/DK2022/050096

§ 371 Date: Nov. 8, 2023

(30) Foreign Application Priority Data
May 11, 2021 (DK) PA 2021 70231

(51) Int. Cl. G01N 21/64; G01N 1/14

(52) U.S. Cl. CPC G01N 21/6428; G01N 1/14; G01N 2021/6439

(57) ABSTRACT

A method for determining a property of at least one liquid and an assessment system for performing the method are described. The method includes providing at least a first liquid and a second liquid at least one of these includes a detectable marker; feeding a portion of the first liquid and a portion of the second liquid in succession into a channel to provide an interfacial contact between the first liquid portion and the second liquid portion; obtaining a row of signals by reading out intensity of the marker of a plurality of volume fractions of the first liquid portion and the second liquid portion located at an interface region comprising the interface between the first liquid portion and the second liquid portion and determining the property from the signal row.

### TECHNICAL FIELD

The invention relates to a method for determining a property of at least one liquid, such as a characteristic property of a liquid-liquid phase interaction of a first liquid and a second liquid, a property of chemical property of a sample liquid and/or of an element thereof. The inventions also relates to an assessment system

### BACKGROUND ART

There a many different techniques for examining liquids for determining physical or chemical properties of liquids. Many of these known techniques requires relative large samples or are relative time consuming.

Many microfluidic test systems have been provide to reduce the required amount of liquid, such a lateral flow systems and capillary flow test devices. Such tests generally requires pre-designs test devises comprising various chemicals, such as immobilized chemicals or reagents. An example of such a device is for example disclosed in US 2019/0118181 where as little as 25 μL may be required.

US 2002/0090644 discloses a method and a device for determining the presence or concentration of sample analyte particles in a medium comprising: means for contacting a first medium containing analyte particles with a second medium containing binding particles capable of binding to the analyte particles; wherein at least one of the analyte or binding particles is capable of diffusing into the medium containing the other of the analyte or binding particles; and means for detecting the presence of diffused particles. The device may for example comprise a T shaped flow device for having the first and second media in adjacent laminar flows.

U.S. Pat. No. 9,310,359 discloses a method of performing a dispersion analysis using Flow Induced Dispersion Analysis (FIDA) for quantification of analytes such as e.g. antigens, toxins, nucleotides (DNA, RNA), etc. For pressure-driven flows of single substances, FIDA corresponds to Taylor Dispersions observed previously for pressure driven flows in tubes or thin capillaries.

PEDERSEN, ME. et al. Flow-Induced Dispersion Analysis (FIDA) for Protein Quantification and Characterization. Methods in Molecular Biology, Clinical Applications of Capillary Electrophoresis, 8 Mar. 2019, pages 109-123 describes Flow Induced Dispersion Analysis (FIDA) enables characterization and quantification of proteins under native conditions. FIDA is based on measuring the change in size of a ligand as it selectively interacts with the target protein. The unbound ligand has a relatively small apparent hydrodynamic radius (size), which increase in the presence of the analyte due to binding to the analyte. The Kd of the interaction may be obtained in a titration experiment and the measurement of the apparent ligand size in an unknown sample forms the basis for determining the analyte concentration. The apparent molecular size is measured by Taylor dispersion analysis (TDA) in fused silica capillary capillaries. It is described that the capillary is filled with sample, followed by injection of a narrow indicator zone of a selective binding indicator, which is subsequently mobilized with sample by a hydrodynamic pressure. The indicator is thus dispersed, mixed with sample, and moved toward the detector. As the indicator mix with sample the single peak (except for noise) of the entire portion of indicator becomes broader. The detected indicator peak reveals if the sample contains the analyte, since the peak shape will change upon binding.

There is still a need for new and reliable techniques for determining properties of a liquid, which does not require large amount of liquid and which may be performed relatively fast.

### DISCLOSURE OF INVENTION

An objective of the present invention is to provide a relatively fast and reliable method for determining a property of at least one liquid, where the required portion of liquid may be relatively small.

In an embodiment, it is an objective to provide a relatively simple method for determining a property of at least one liquid, which method is relatively fast and economical feasible.

In an embodiment, it is an objective to provide a relatively simple method for determining a property of at least one liquid, which method does not require use of specifically designed test cartridges and/or of expensive reagents.

In an embodiment, it is an objective to provide a relatively fast and reliable method for determining a characteristic property of a liquid-liquid phase interaction between two liquids, where the required portion of liquids may be relatively small.

In an embodiment, it is an objective to provide a relatively fast and reliable method for determining a chemical property of a sample liquid, such as concentration of, stability or other characteristics of an element of the liquid.

These and other objects have been solved by the inventions or embodiments thereof as defined in the claims and as described herein below.

It has been found that the inventions or embodiments thereof have a number of additional advantages, which will be clear to the skilled person from the following description.

The phrase “molecular interaction” means any non-covalent interactions between molecules as well as within one or more molecules.

The phrase “interaction and/or reaction” include any interactions or reactions both covalent and non-covalent, between liquids or elements thereof.

The term “element” is herein used to mean any elements of the respective liquids including any ions portion of matter comprising at least one molecule, such as an organic molecule or an inorganic molecule an ion. The element may for example comprise an aggregate, a cluster, a complex or any combinations comprising one or more of these. The terms “element” and “particle” may be used interchangeable.

The term “binding partner” is herein used to mean any molecule or group of molecules, capable of non-covalent interacting with an element.

The term “marker” is herein used to mean any intrinsic or extrinsic marker capable of being detected by a reader arrangement. In an embodiment, the marker comprises an element, group of elements, moieties and/or any combination comprising one or more of these, where the marker is capable of being detected by a reader arrangement directly and/or after being influenced from an external and/or internal source.

The term “reader arrangement” means any detector or detector system capable of detection a signal, such as an optical signal and/or an electrochemical signal.

The term “substance” is used to designate any matter that uncountable i.e. not in the form of distinct items. The substance may comprise a homogeneous or inhomogeneous mixture of components and/or elements.

The term “buffer” means an aqueous solution, which is resistant to changes in pH value in the context where the buffer is used. The buffer advantageously comprises an aqueous solution of either a weak acid and its salt or a weak base and its salt.

Unless otherwise specified the pH value of a buffer is determined at 20° C.

The terms “test” and “assay” are used interchangeable.

The term “equilibrium” and “chemical equilibrium” are used interchangeable.

The term “row of signals” is herein used to mean a number of signals obtained by intensity readings determined along the length of the channel. The intensity readings may be simultaneous readings, consecutively readings and/or readings obtained within a time frame T_{f}, such as a time frame T_{f} of up to about 24 hours, such as up to about 10 hours, such as up to about 5 hours, such as up to about 1 hour.

The terms “element” and “component” are used interchangeable.

It should be emphasized that the term “comprises/comprising” when used herein is to be interpreted as an open term, i.e. it should be taken to specify the presence of specifically stated feature(s), such as element(s), unit(s), integer(s), step(s) component(s) and combination(s) thereof, but does not preclude the presence or addition of one or more other stated features.

Reference made to “some embodiments” or “an embodiment” means that a particular feature(s), structure(s), or characteristic(s) described in connection with such embodiment(s) is included in at least one embodiment of the subject matter disclosed. Thus, the appearance of the phrases “in some embodiments” or “in an embodiment” in various places throughout the specification is not necessarily referring to the same embodiment(s). Further, the skilled person will understand that particular features, structures, or characteristics may be combined in any suitable manner within the scope of the invention as defined by the claims.

The term “substantially” should herein be taken to mean that ordinary product variances and tolerances are comprised.

Throughout the description or claims, the singular encompasses the plural unless otherwise specified or required by the context.

All features of the invention and embodiments of the invention as described herein, including ranges and preferred ranges, may be combined in various ways within the scope of the invention, unless there are specific reasons not to combine such features.

It has been found that the method and system for determining a property of at least one liquid may provide very accurate determinations very fast and by use of very small volume of liquid portions. In addition the method does not require specifically designed cartridges and many characteristics.

The inventors have observed that the signal obtained in a Flow Induced Dispersion Analysis (FIDA) may have one or more signal perturbations, i.e. signal spikes which are separate from a main signal and exceeds the noise level. It was surprisingly found that such signal perturbations may be applied for determining a property of the liquid or liquids subjected to the analysis.

The method of the invention comprises
providing at least a first liquid and a second liquid wherein at least one component of the first and/or the second liquid comprises a detectable marker;
feeding liquid into a channel comprising feeding a portion of the first liquid and a portion of the second liquid in succession into a channel to provide an interfacial contact between the first liquid portion and the second liquid portion;
obtaining a row of signals by reading out intensity of the marker of a plurality of volume fractions of the first liquid portion and the second liquid portion located at an interface region comprising the interface between the first liquid portion and the second liquid portion and
determining the property of the at least one of the first liquid and the second liquid from the signal row.

The determination is based on observation of one or more signal perturbations or lack of signal perturbations of the row of signals obtained at the interface region.

As it will be explained further below the size (height as well as width) of the one or more signal perturbations, the shape of the one or more signal perturbations as well as the location of such one or more signal perturbations, may be applied in the determination of the property of the liquid(s).

As it will be clear from the below description the method may be applied with a high flexibility for obtaining a single determination of a property or for performing a series of determinations for one or more liquids, which describes properties of the liquid(s) in more details, such as for generation of a phase diagram in N dimensions, such as in two or three or more dimensions.

The first and the second liquids may in principle be any liquids, which differs in at least one aspect.

The signal row of signals comprises intensity signals read out from volume fractions of the first liquid portion and the second liquid portion along the length of the channel, wherein the volume fractions are located at the interface region comprising the interface.

The inventor has found that signal perturbations in the form of one or more spike shaped intensity signals may be detected at the interface region and based on these signal perturbations the property or properties of the first liquid, the second liquid and/or a property or properties such a characteristic property of a relationship between the first and the second liquid may be determined.

It is believed that the contact between the first liquid portion and the second liquid portion in the may result in phenomena of disturbance at the interface region, such as a displacement, a formation of drops and/or an aggregation of small volume fractions at the interface region in dependence of properties of the liquid portions. Such disturbance e.g. provided by a displacement, a formation of drops and/or an aggregation of small volume fractions at the interface region may result in one or signal perturbations which signal perturbations exceed the noise level and are distinguishable from the main signal provided by the major part of the marker.

The signal perturbations may be in the form of intensity discontinuities, such as intensity spikes.

In an embodiment, this may be determined by the readings of the marker, where a row of intensity readings at the interface region is obtained and the row of intensity readings will show a base line and in dependence of the property or properties of the liquids may show intensity discontinuities relative to the base line in the form of one or more intensity spikes.

The observed spikes may indicate the phenomena of disturbance at the interface region, for example resulting from formations of small drops, e.g. of liquid-liquid phase effects, such as separation, demixing, condensate formation, denaturation products, reaction products and similar. It may be directly read out from the row of signals that some chemical or physical effects takes place, which thereby may make the method even faster and for example suitable for screening of liquids.

The method of determine one or more properties may conveniently be at least partly based on presence or absence of intensity spikes at the row of signals. In addition, the number, shape, distances and height of such intensity spikes may be applied for very accurate and fast determinations.

To ensure a desired time for allowing the phenomena of disturbance to take place the reading out is performed after a contacting time T_{c} from establishing the interfacial contact between the first liquid portion and the second liquid portion.

The contacting time T_{c} may preferably be at least 1 sec, such as at least about 0.5 minutes, such as at least about 1 minute, such as at least about 2 minutes, such as up to about 5 hours, such as up to about 1 hours, such as up to about 0.5 hours, such as between 5 sec and 20 minutes.

The contacting time T_{c} may be selected in dependence of the liquid portions and the type of property or properties that are to be determined. If a first set of readings providing a row of signals after a first contacting time T_{c} does not show any signs of intensity spikes, a second or further readings of rows of signals may be obtained until intensity spikes are shown or until it is estimated that no intensity spikes will be formed e.g. based on experience of previous determination of the property or properties in question. It has been found that if no intensity spikes has formed within 25 hours from establishing the interfacial contact between the first liquid portion and the second liquid portion, it may be expected that no-intensity spikes will form.

The interface region has a length determined along the length of the channel and comprising the interface. The interface region length may be at least about 1 mm, such as at least about 0.2 cm, such as at least about 0.5 cm such as from about 1 cm to about 5 m, such as from about 2 cm to about 1 m.

The interface region length may be selected in dependence of the inner dimension of the channel and the contacting time T_{c} as well as in dependence of the liquid portions and the type of property or properties that are to be determined.

In an embodiment, the signal row comprises a row of intensity readings comprising at least about 10 intensity readings, such as at least about 50 intensity readings, such as at least about 100 intensity readings, such as at least about 500 intensity readings, such as at least about 1000 intensity readings. The more intensity readings the faster may the intensity spikes be observable and the more accurate may the determination(s) be.

The reading out of the intensity signal row along the interface region length, comprises a row of intensity readings comprising at least about 10 intensity readings per cm interface region length, such as at least about 50, such as at least about 100, such as at least about 500, such as at least about 1000 intensity readings per cm interface region length.

The determination of the property or properties may comprise determination of one or more intensity discontinuities relative to the base line. Preferably, the determination of the property or properties comprises determination of presence or absence of intensity spike(s) relative to the base line, such as height width and/or shape of intensity spike(s) and/or number and/or frequency of intensity spike(s).

The determination of the property may comprise determination of one or more intensity discontinuities (signal perturbations) provided by one or more volume fragments having a volume of 25% or less, such as 15% or less, such as 10% or less such as 5% or less than any of the portion of said first liquid and the portion of the second liquid.

In an embodiment, the determination of the property comprises determination of one or more intensity discontinuities in the form of one or more intensity spikes of the signal obtained from the marker. Advantageously, an intensity spike has a total intensity representing up to 10%, such as up to 5%, such as up to 3% of the total intensity of the signal obtained from the marker of the portion of the first liquid and the second portion of the second liquid fed to the channel.

Thereby a signal perturbations in the form of an intensity spike is easily distinguishable from the main signal provided by the major part of the marker.

The major part of the marker, e.g. 50% or more conveniently provide a main single peak signal.

The signal obtained from the marker may advantageously be an optical signal in in the form of an intensity of a wavelength range emitted or reflected by the marker and/or intensity absorbed by the marker, such as a marker operating in the UV/Vis wavelength range e.g. from about 190 nm to about 700 nm.

In an embodiment, the determination of the property comprises determination of one or more signal perturbations relative to a base line. Preferably the determination of the property comprises determination of presence or absence of one or more intensity spikes relative to the base line, wherein also the other parameters of detected spike(s) may be applied for determining the property, such as height and/or width and/or shape of intensity spike(s), number and/or frequency of intensity spike(s).

The baseline may be determined by obtaining a baseline row of signals comprising reading out intensity of the marker of a plurality of volume fractions of the first liquid portion and the second liquid portion, comprising reading in total at least 50% of the signal from the detectable marker, such as at least 70%, such as at least 90% such as at least 99% of signal from the marker and generating a best fit continuous curve omitting local peaks.

Usually the baseline comprises a single peak of intensities representing the major of the marker, e.g. 50% or more.

In an embodiment, the obtaining of the baseline row of signals comprises the obtaining of the row of signals and wherein the spikes is determined as the local peaks deviating from the baseline.

In an embodiment, an intensity spike has an intensity of at least 2 times the background noise, preferably at least 3 times, such as at least 5 times the background noise.

The intensity spike may conveniently have a signal/noise ratio of at least 2, preferably at least 3, such as at least 5 or higher.

In an embodiment, an intensity spike may preferably have a spike height value exceeding the baseline least 2 times the background noise, preferably at least 3 times, such as at least 5 times the background noise.

The method may comprise holding the first liquid portion and the second liquid portion in non-flowing condition in at least a part of the contacting time T and/or providing the first liquid portion and the second liquid portion to a flow within the channel in at least a part of the contacting time T.

In an embodiment, the method comprises performing a plurality of the intensity readings of the row of intensity readings simultaneously, e.g. by using a reader arrangement comprising an image acquisition device, such as a camera, preferably a digital camera.

In an embodiment, the method comprises performing a plurality of the intensity readings of the row of intensity readings as a function of time, e.g. by using a reader arrangement comprising an electronic detector such as a photomultiplier tube (PMT), charged coupled detector (CCD) photo resistor and/or photodiodes e.g. an avalance photo diode.

Advantageously, the row of intensity readings is acquired with in a time frame of up to about 24 hours, preferably within a time frame T_{f} of up to about 10 hours, such as within a time frame of up to about 5 hours, such as within a time frame of up to about 1 hour, such as within a time frame of up to about 0.5 hour time frame of up to about 0.2 hour. The time frame T_{f} may be determined from the time of acquisition of the first intensity signal to the time of acquisition of the last intensity signal that is deviating from the base line of the row of signals.

The liquids may be aqueous liquids, organic liquids or mixtures thereof.

The first liquid and the second liquid are conveniently in liquid state at the test temperature, preferably at a temperature in the interval from about 5° C. to about 90° C., such as in the interval from about 10° C. to about 50° C.,

Advantageously, first liquid portion and the second liquid portion is/are a single phase liquid portion at the time of feeding it to the channel, preferably each of the first liquid portion and the second liquid portion is single phase liquid portion at the time of feeding it to the channel. Thereby, the formation of noise may be reduced which may result in a more accurate determination.

The reader arrangement applied may advantageously comprise an optical reader, such as the optical readers mentioned above, such as a reader comprising one or more photo resistor and/or photodiodes or a digital reader with a frame rate of at least about 10/sec.

In an embodiment, the first liquid and the second liquid differs from each other in at least one chemical and/or physical property.

In an embodiment, the first liquid and the second liquid differs from each other in at least one chemical property. Examples of such at least one chemical property includes
presence/absence at least one element, such as a chemical substance, (molecule)/solvent
concentration of at least one element, such as a chemical substance, (molecule)/solvent
reactivity of at least one element, such as a chemical substance, (molecule)/solvent
stability of at least one element, such as a chemical substance, (molecule)/solvent
pH value,
ionic strength
concentration of dissociated salt, or
a combination comprising one or more of the before mentioned.

In an embodiment, the first liquid and the second liquid differs from each other in at least one physical property. Examples of such at least one physical property includes
temperature,
viscosity,
boiling point,
electrical Conductivity,
surface tension, (hydrophilicity/hydrophobicity) or,
a combination comprising one or more of the before mentioned.

In a preferred embodiment, the determination of the property of at least one liquid comprises determining a characteristic property of a liquid-liquid phase interaction of the first liquid and the second liquid from the row of signals.

The phrase “characteristic property” means a chemical and/or physical property that is not dependent on the amount of sample and that is unique to the liquid-liquid phase interaction at the given conditions.

Examples of characteristic properties include freezing/melting point, boiling/condensing point, density, viscosity, and solubility.

Advantageously, such a characteristic property may include a liquid-liquid phase separation (LLPS), a liquid-liquid mixing, or a liquid-liquid phase reaction.

The liquid-liquid phase interaction may as explained above may be reflected by the formation of small droplet formations, such as pL (pico litre), fL (fento litre) or even al (atto litre) drop formations e.g. fringe shaped drop formations at the interface region.

The characteristic property of the liquid-liquid phase interaction may advantageously comprises a characteristic property of ability of phase separation and/or mixing between the first and the second liquid, ability of forming gradient at an interface region between the first and the second liquid, ability of forming aggregation at an interface region between the first and the second liquid, ability of reactions between element(s) of the first and the second liquid, ability of fully or partly degrading and/or modifying a structure of an element of the first liquid and the second liquid at an interface region between the first and the second liquid or any combinations thereof.

In an embodiment, the characteristic property of the liquid-liquid phase system comprises.
a liquid-liquid phase separation,
a liquid-liquid phase demixing,
a liquid-liquid phase condensate formation,
a liquid-liquid phase transition/critical point/diagram, and/or
isothermal/non-isothermal interaction

The first liquid and the second liquid may for example comprise the same components, but in different concentrations, such as different concentrations of ions of a dissolved salt.

By performing a plurality of determinations and varying the difference in concentration an entire diagram of the interface interactions of the first liquid and the second liquid may be drawn up.

By performing a plurality of determinations and varying the temperature an entire diagram of the interface interactions of the first liquid and the second liquid as a function of temperature may be drawn up.

In an embodiment, a primary liquid of the first liquid and the second liquid comprises a protein, and a secondary liquid of the first liquid and the secondary liquid differs from the primary liquid with respect to one or more of the following:
PH value,
presence or concentration of a reactant for the protein,
presence or concentration of a selected ion or ions (e.g. from a dissolved salt, such as Na⁺/Cl⁻) and/or
absence or concentration of the protein in the primary liquid.

Advantageously, at least one of the first liquid and the second liquid comprises a buffer system. Preferably, at least the primary liquid comprises a buffer system and more preferably, both the primary liquid and the secondary liquid comprises a buffer system. Thereby the pH value of the first and the second liquid is simpler to control, and unexpected pH changes may not alter or influence the determined signals. The buffer system of the secondary liquid may be equal to or different from the buffer system of the primary liquid.

In an embodiment, the determination of the property of at least one liquid comprises determining chemical property of a sample liquid. The sample liquid may be provided as one of the first liquid and the second liquid wherein the other of the first liquid and the second liquid is provided as a test liquid for testing the sample liquid.

Thereby the method may conveniently be applied for determining a property of a sample, such as a sample, which may be fully or partly unknown

The determination of the chemical property of the sample liquid may for example comprise determining a chemical property selected from
presence/absence at least one element, such as a chemical substance, (molecule)/solvent,
concentration of at least one element, such as a chemical substance, (molecule)/solvent,
reactivity of at least one element, such as a chemical substance, (molecule)/solvent,
stability of at least one element, such as a chemical substance, (molecule)/solvent,
pH value,
ionic strength and/or
a combinations comprising one or more of these.

Thereby the method may for example be applied for examination of a sample of a natural fluid, such as a sample of a biological fluid or of wastewater (e.g. from a chemical plant).

In an embodiment, the determination of the chemical property of the sample liquid comprises determining a chemical property associated to a target element in the sample liquid or to a target element suspected to be present in the sample liquid. Such a target element may conveniently be a target protein.

The method of the invention may for example be applied in a diagnostic procedure. This may in particular be beneficial, where only very small amount of the liquid sample is available.

In an embodiment, the determination of the chemical property of the sample liquid comprises determining reactivity of one or more elements of the sample liquid relative to one or more components of the test liquid and/or relative to exposure to a pH value at an interface region between the sample liquid and the test liquid.

The formation and structure of intensity spikes of the row of signals may reveal if and to which degree a reaction takes place.

In an embodiment, the determination of the chemical property of the sample liquid comprises determining a stability property of a target protein, wherein the test liquid has a different pH value and/or a higher concentration of one or more selected ions, such as guanidium ion.

It may for example be determined if the sample liquid comprise one or more elements that will denaturize or degrade at the pH value of the liquid.

The test may for example be repeated using test liquids at another/other pH value(s).

In an embodiment, the determination of the chemical property of the sample liquid comprises determining a denaturation property and/or an aggregation property of a target protein, wherein the test liquid has a different pH value than the sample liquid components, such as a pH value of 4 or less or 8 or higher.

In an embodiment, at least one of the first liquid and the second liquid comprise a protein, such as an antibody (monoclonal or polyclonal), a nanobody, an antigen, an enzyme and/or a hormone; a nucleotide; a nucleoside; a nucleic acid, such a RNA, DNA, PNA or any fragments thereof and/or any combinations comprising at least one of these. Preferably, at least one of the first liquid and the second liquid comprises a protein, such as the target protein, wherein the protein is a bioprotein (naturally occurring), such as an enzyme or an antibody.

Example of suitable bioproteins includes IgG, IgM, IgA or IgD.

IgG is the main antibody in blood. It is the only isotype that can pass through the placenta, and IgG transferred from the mother's body protects a newborn until a week after birth. IgG widely distributed to the blood and tissue, and protects the body.

IgM is made up of 5 antibodies. IgM has a key role in the initial immune system. It is distributed to the blood.

Secreted IgA is made up of two antibodies. It is distributed to serum, nasal discharge, saliva, breast milk and bowel fluid. Breast milk protects the gastrointestinal tract of newborns from bacterial and viral infection (maternal immunity).

IgD is present on the surface of B cells and plays a role in the induction of antibody production.

IgE is believed to be related to immunity reactions to parasites, and has recently become known as a key factor of allergies such as pollinosis.

Advantageously, at least one of the first liquid and the second liquid comprises natural liquid, biological liquid, protein containing fluid, organic solvent and/or inorganic solvent.

In principle, any liquid may be applied. However, it is preferred that at least one of the liquids comprises an organic element. The method of the invention is specifically advantageous where the amount of liquid for the first liquid and/or for the second liquid is limited to a relatively small amount or where many assays is to be performed. In an embodiment, the method of the invention is applied as a high throughput assay e.g. for screening a large number of liquids.

Advantageously, at least one of the first liquid and the second liquid comprises a biological liquid. The biological liquid may for example be obtained from a living organism, such as from an animal, a human being or a plant. The biological sample may be a fraction, a concentrate a dilution or a derivative of liquid obtained from a living organism.

The biological liquid may for example be a sample from a human being or an animal, preferably selected from saliva, urine, blood, cell fluid, cerebrospinal fluid, extracellular fluid combinations thereof and fragments thereof

The sample may be pre-treated to form the first liquid or the second liquid. The pre-treatment may conveniently comprise dilution, addition of a buffer system, filtration and/or adding a marker, preferably the biological liquid form part of or constitutes the sample liquid.

The detectable marker may bound to an element, such as a target element or it may be an inherent part of an element of the first and/or the second liquid, such a target element.

The detectable marker may advantageously comprise a marker molecule located in one of the first liquid and the second liquid. In an embodiment, the marker may be capable of being attached to or being bonded to an element in or suspected to be in the other of the first liquid and the second liquid.

In an embodiment, the detectable marker comprises a marker molecule located in one of the first liquid and the second liquid and is capable of being attached to or being bonded to an element in or suspected to be in one of the first liquid and the second liquid upon influence of, such as interaction with the other of the first liquid and the second liquid.

In an embodiment, the marker is an intrinsic marker and/or an extrinsic marker.

In an embodiment, the marker is sensitive to a conformational change of an element of the first liquid and the second liquid, such as a change of structural shape of a macromolecule in one of the first liquid and the second liquid, such as a conformational change of a protein and/or a complex.

In an embodiment, the marker changes signal, such as wavelength or intensity in dependence of conformation of an element and changes thereof, such as in dependence of change in binding/dissociation and/or in structure.

Advantageously, the marker is an optically readable marker, such as a light absorbing marker and/or a fluorescent marker, preferably operating in the UV/Vis wavelength range preferably from about 190 nm to about 700 nm.

Advantageously, the method is carried out at constant temperature, e.g. provided by a temperature control.

In addition, it is desired that the pressure is kept constant, except for the pressure difference applied for flowing the sample in the channel.

During or prior to the assay the liquid portions should preferably not be subjected to any temperature jump and/or pressure jump that brings the individual liquid portions to a state of non-equilibrium.

In an embodiment, the feeding of a liquid into the channel comprises feeding an additional portion of the first liquid and/or feeding an additional portion of the second liquid in into the channel to provide at least one additional interfacial contact between the first liquid and the second liquid.

Thereby, several interfaces or interface regions between liquids may be examined in the same assay. This makes the method even more effective. In principle, the method may comprise feeding N portions of liquids into the channel wherein adjacent portions of liquid differs from each other in at least one chemical and/or physical property and wherein a plurality of the liquid portions, such as at least every second, comprises a marker, providing the N liquid portions to laminar flow within the channel, obtaining a row of intensity signals by reading out respective markers of volume fractions at the respective interfaces between liquid portions and determining respective properties of a plurality of the liquid portions.

In an embodiment the number N is 100 or more. In an embodiment the number N is at least 3, such as at least 4, such as at least 5.

As a liquid portion has passed in the entire length of the channel, it may be collected in a waste reservoir or simply be disposed of depending of the type of liquid.

In an embodiment, the feeding of a liquid into the channel comprises feeding an additional portion of at least one additional liquid, wherein the at least one additional liquid differs from the first liquid and the second liquid. in at least a chemical and/or a physical property.

The channel may be provided by a tube comprising the channel, such as a glass tube or a polymer tube preferably having dimensions preventing undesired turbulence of the liquid portions. The channel may conveniently be a microfluidic channel, such as a microfluidic channel having a maximal inner dimension of about 1 mm or less, such as of about 0.5 mm or less, such as of about 0.1 mm or less, such as of about 75 μm or less. The channel may have any cross sectional shape, such as rectangular, circular or oval. In practice, it is simplest applying a circular channel, such as a capillary of glass or polymer. The channel may conveniently be transparent for at least one wavelength of the marker for allowing optical read out.

In an embodiment, the channel has equal inner dimension(s) along at least a length section, such as along its entire length. Thereby the velocity will be simple to adjust and the channel may be simple to produce.

In an embodiment, the channel has a tapered channel length section, such as a narrowing channel length section and/or a widening channel length section.

The inner surface of the channel may advantageously be hydrophilic where the liquid portions applied are hydrophilic liquids, such a water containing liquids. The hydrophilic inner surface may for example be provided by applying a hydrophilic coating to the inner surface. The coating may conveniently be relatively thin, such as op to a thickness of 10 molecule layers, such as up to 5 molecule layers.

The liquid portions may be fed to the channel at same or different pressure such as one or more pressures of at least 50 mbar. The liquid portions may be fed to the channel at same or different pressure such as one or more pressures to fill each of the respective liquid portions into the channel during a period of up to about 5 minutes per liquid portion, such as from 1 second to 2 minutes per liquid portion.

In an embodiment, the method comprises providing that the first liquid portion and the second liquid portion, after being fed to the channel, are in non-flowing condition during at least a part of the contacting time T_{c}, such as during the entire contacting time T_{c}.

In an embodiment, the method comprises providing that the first liquid portion and the second liquid portion are in non-flowing condition during at least a part of the time frame T_{f} of performing the intensity readings, such as during the entire time frame T_{f} of performing the intensity readings.

This embodiment allows the channel to be relative short, such as a few centimeters for example 5 cm or larger. In an embodiment, disposable tubes of short length e.g. between 5 and 20 cm may be applied. This may be beneficial, where one or more of the liquid portions comprises or is suspected of comprising toxic or otherwise dangerous elements.

Advantageously, the method comprises providing the first liquid portion and the second liquid portion to a flow within the channel.

In an embodiment, the provision of the first liquid portion and the second liquid portion to flow within the channel comprises, subjecting the liquid portions to a laminar flow for at least about 10 seconds, such as at least about 30 seconds, such as at least about 1 minute, such as at least about 2 minutes. Preferably, the method comprises providing the first liquid portion and the second liquid portion to laminar flow within the channel for a period of at least about 10 seconds, such as at least about 30 seconds, such as at least about 1 minute, such as at least about 2 minutes.

Advantageously, the provision of the first liquid portion and the second liquid portion to flow within the channel comprises subjecting the liquid portions to a flow velocity of from about 0.1 cm/min to about 50 cm/sec, such as from about 1 cm/min to about 25 cm/sec, such as from about 5 cm/min to about 10 cm/sec, such as from about 10 cm/min to about 5 cm/sec.

In an embodiment, the method comprises adjusting the flow velocity prior to and/or during at least a part of the reading out. Where the observed spikes are very tight it may be beneficial to reduce the flow velocity during at least a part of the intensity readings.

Thus in an embodiment the velocity is kept above a selected velocity as long as no intensity spikes is observed and at the moment a first intensity spike is observed, the velocity is reduced to or below the selected velocity. Thereby, the assay may be speeded up, while simultaneously maintaining a desired velocity during reading out at the liquid-liquid interface region.

In an embodiment, the method comprise reducing the flow velocity of the liquid portions and/or subjection the liquid portions a flow stop, such as a temporally flow stop when the read intensity of two or more consecutive readings differs beyond a threshold.

In an embodiment the method comprises providing the flow of the liquid portions to a temporally flow stop. This may for example be beneficial where diffusion property of one element from one liquid portion to another liquid portion is to be observed or determined.

The reading out of the marker of a plurality of volume fractions of the first liquid portion the second liquid portion advantageously comprises reading out at one or more reading locations of the channel. The reading location(s) may conveniently be stationary reading location(s). Thereby the reader remain stationary and immobile, which has shown to provide very accurate reading out.

Advantageously, the at least one reading of the volume fraction at the interface between the first liquid portion and the second liquid portion is performed when the volume fraction is located at and passing by the reading location(s) of the channel.

Preferably, the reading out comprises performing consecutive readings or a reading over time from different volume fractions of the liquid portions as the respective volume fractions are passing the at least one reading location of the channel.

In an embodiment, the method further comprise acquiring an image of a part of the liquid portions located in an image acquisition length section of the channel, wherein the image acquisition length section is located downstream to the at least one reading location. The part of the liquid portions imaged may preferably comprise volume fractions previously read at the at least one reading location and wherein the read intensity of two or more consecutive readings differs beyond a threshold. This can be provided by calculating the time of arrival of the volume fractions previously read to the image acquisition length section.

The camera applied may advantageously be a high pixel digital microscope camera, such as a CCD camera, CMOS camera or similar.

The invention also comprises an assessment system for determining a property of at least one liquid according to the method described herein. The assessment system comprises
at least two mother containers for containing at least a first liquid and a second liquid,
a channel,
a reader arrangement for reading out a marker signal from a liquid located in said channel,
a withdrawing and pump arrangement for withdrawing liquid portions from said respective mother containers and for feeding said respective liquid portions in succession into said channel to provide an interfacial contact between said liquid portions, and
a computer system programmed for controlling the elements of the system for carrying out the method as described above.

In an embodiment, the assessment system is as the apparatus described in copending application PCT/DK2021/050079, with the difference that the computer system of the assessment system is programmed to perform the method described above and as claimed in the claims. In addition the assessment system may be in an embodiment, be free of any condition jump arrangements.

In an embodiment, the containers are as described in PCT/DK2021/050079.

In an embodiment, channel and a pump arrangement are as described in PCT/DK2021/050079.

In an embodiment, the reader arrangement is as described in PCT/DK2021/050079.

In an embodiment, the c withdrawing arrangement are as described in PCT/DK2021/050079.

Advantageously, the computer system is programmed for performing the method described herein, after the first liquid and the second liquid has been applied in the respective mother containers.

The reader arrangement may advantageously comprise an optical reader. The optical reader is preferably located to read out from the channel at one or more one channel read out location.

The optical reader may advantageously be stationary (non-movable) during the read out.

The channel may have an inlet for feeding the liquid portions into the channel. The channel read out location is advantageously located at a selected distance from the inlet determined along the length of the channel. The distance between the inlet and the read out location may conveniently be at least about 2 cm, such as at least about 5 cm, such as between 0.1 and 1 m. Where the distance is very long the assay time may be relatively long. A very short distance, such as less than 2 cm, may result in less accurate determinations.

The channel may advantageously be as described above.

Preferably, the assessment system may be configured for feeding the liquid portions to the channel at same or different pressure such as described above.

The withdrawing and pump arrangement is advantageously configured for feeding the liquid portions to the channel at same or different pressure such as one or more pressures of at least 50 mbar, preferably to fill each of the respective liquid portions into the channel during a period of up to about 10 minutes, such as from 5 seconds to 5 minutes.

Advantageously, the withdrawing and pump arrangement is configured for flowing said first liquid portion and said second liquid portion within said channel at a velocity of from about 0.1 cm/min to about 50 cm/sec, such as from about 1 cm/min to about 25 cm/sec, such as from about 5 cm/min to about 10 cm/sec, such as from about 10 cm/min to about 5 cm/sec.

In an embodiment, wherein the assessment system is configured for obtaining a row of signals by reading out intensity of a marker of a plurality of volume fractions located in the channel. The assessment system may preferably be configured for performing consecutive intensity readings from different volume fractions of liquid portions flowing in the channel as the respective volume fractions are passing the at least one reading location of the channel.

The assessment system may conveniently be configured for reducing the flow velocity of the liquid portions and/or subjection the liquid portions to a flow stop, such as a temporally flow stop when the read intensity of two or more consecutive readings differs beyond a threshold e.g. as described above

In an embodiment, the assessment system comprises a camera arranged for acquiring images of a liquid located in an image acquisition length section of the channel e.g. as described above.

All features of the invention(s) and embodiments thereof including ranges and preferred ranges can be combined in various ways within the scope of the invention, unless there are specific reasons not to combine such features.

### BRIEF DESCRIPTION OF THE EXAMPLES AND DRAWING

The invention is being illustrated further below in connection with examples and embodiments and with reference to the figures. The figures are schematic and may not be drawn to scale. The examples and embodiments are merely given to illustrate the invention and should not be interpreted to limit the scope of the invention

FIG. 1 illustrates an embodiment of an assessment system of the invention suitable for determining a property of at least one liquid as described herein.

FIG. 2 illustrates a close up side view of a section of a channel of a tube into which a first liquid portion and a second liquid portion have been fed.

FIG. 3a illustrates a close up side view of a section of a channel of a tube into which a first liquid portion, a second liquid portion and a third liquid portion have been fed.

FIG. 3b illustrates an enlarged side view of a section of a channel of a tube into which a first liquid portion, a second liquid portion and a third liquid portion have been fed and where estimated average mixing gradients have been illustrated.

FIG. 4 is a plot of a row of intensity signals obtained in example 1.

FIGS. 5-12 are plots associated to the examples described below.

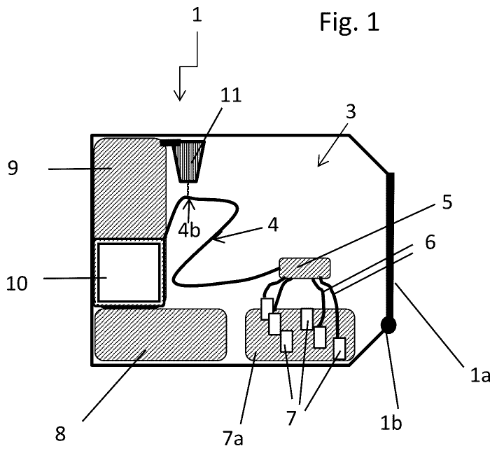

The assessment system of FIG. 1 comprises an apparatus 1 having a compartment 3 comprising a microfluidic unit 4 forming a channel.

The compartment 3 comprises a plurality of mother sample containers 7 for containing at least a first liquid and a second liquid. The sample containers 7 are arranged in a support unit 7a. The support unit 7a advantageously comprises a temperature controller for temperature controlling of the liquids in the respective mother sample containers 7 to a selectable temperature. The compartment 3 comprises a withdrawing arrangement comprising a pump arrangement 5, connected to a plurality of withdrawing tubes 6. Each tube advantageously comprises a needle adapted for penetrating a cover membrane on the respective of mother sample containers 7. The respective tubes 6 may be manually inserted into desired mother sample containers, by penetrating the membrane of the mother sample containers with the needles at their ends. In an embodiment, the apparatus 1 comprises a robot arm adapted for insert the tube(s) 6 into selected mother sample container(s).

In a variation of this embodiment the withdrawing arrangement comprising a single withdrawing tube which may be moved from one mother sample container to another for collecting the first liquid portion and the second liquid portion and optionally further liquid portion(s).

The apparatus 1 comprises a hinged 1b lid 1a into the compartment 3 for providing access.

In this embodiment, the microfluidic unit 4 is a tube with a narrow diameter e.g. as described above. The tube 4 is connected to the pump arrangement, such that the pump can pump withdrawn mother sample into the channel of the microfluidic unit 4 at a desired pressure difference.

The compartment 3 further comprises a computer 9 forming part of a computer system. The computer is adapted for controlling the elements of the apparatus 1. The computer 9 is connected to a reader arrangement 11 located for optically reading from a reading location 4b of the channel of the microfluidic unit 4.

The compartment 3 comprises temperature controller 8 for controlling the temperature in the compartment 3 to maintain a desired temperature.

A waste chamber 10 is located for collect used liquid portions and optional cleaning fluid passed through the channel of the microfluidic unit 4

In use, a first liquid portion and a second liquid portion are withdrawn from respective selected mother sample containers 7 using the tubes 6 and the pump arrangement 5 of the withdrawing arrangement.

The liquid portions are fed in succession into the channel of the microfluidic unit 4 to provide an interfacial contact between the first liquid portion and the second liquid portion. The feeding of the liquid portions may be provided at a relatively high pressure difference to ensure that the introduction of is performed relatively fast. The liquid portions are thereafter pumped towards the reading arrangement 11 as a desired flow as described above option ally comprising one or more flow stop. After a contacting time T_{c} the interface region reaches the reading location 4b. The pressure and thereby the flow velocity may be reduced e.g. as described above to provide that the interface region is passing the reading location 4b at a desired slow velocity to ensure a desired number of readings of volume fractions of said first liquid portion and said second liquid portion located at an interface region. While the sample is passing the reading location 4b, the reader arrangement 11 is performing a plurality intensity readings at a desired reading rate e.g. as described above.

The variation of the assessment system the system comprises a personal computer forming part of the computer system and in data connection with the computer 9.

The computer system is programmed for performing the method described herein.

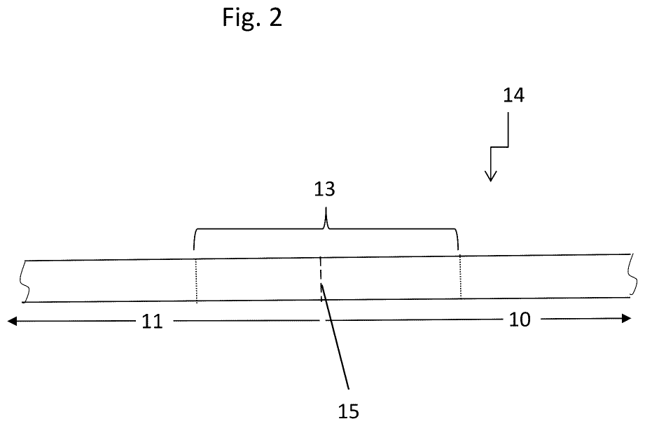

FIG. 2 show a section of a tube 4 with a channel into which a first liquid portion 10 and a second liquid portion 11 have been fed only a part of the respective liquid portions 10, 11 is seen. The first liquid portion 10 and the second liquid portion 11 forms an interface 15 where the first liquid portion 10 and the second liquid portion 11 are in interfacial contact. After a contacting time T_{c}, an interface region 13 comprising the interface 15 is formed.

The first liquid portion 10 and the second liquid portion 11 differs from each other with respect to at least one chemical and/or physical property.

For example, the first liquid portion 10 may comprise a buffer with a surplus of component A and no or only a minor amount of B (molar content of A>molar content of component B) and the second liquid portion 11 may comprise a buffer with a surplus of component B and no or only a minor amount of component A (molar content of B>molar content of A). A marker may for example be intrinsic or be bound to one of the component A or B.

After the contacting time T_{c} the row of intensity readings of the marker may be performed of a plurality of volume fractions of the first liquid portion and said second liquid portion located at the interface region 13. If and to which degree phase separation take place may be determined from the row of intensity signals as described above. If the row of intensity signals show intensity discontinuities relative to a base line, this is an indication that liquid-liquid phase separation takes place and the degree of discontinuities, such as size, shape and/or number of intensity spikes may indicate the degree of liquid-liquid phase separation.

The buffer of the respective first liquid portion 10 and the second liquid portion 11 may be equal or different, such as Phosphate buffer, PBS (Phosphate buffered saline) buffer, tris (tris(hydroxymethyl)aminomethane) buffer, hepes ((4-(2-hydroxyethyl)-1-piperazineethanesulfonic acid) buffer etc.

In an embodiment, the setup illustrated in FIG. 2 is applied for analyzing for isothermal liquid-liquid phase separation.

Component A and component B may for example be components that are known from liquid-liquid phase separation systems, such as proteins, oligonukleotid (DNA, RNA etc.), polymers (dextran, peg, etc.), salts (in dissolved condition), such as salts of the Hofmeister series or lyotropic series.

The volume of the first liquid portion 10 and a second liquid portion 11 may in this example be between 40 nL and 9 μL.

Other examples of the first liquid portion 10 and a second liquid portion 11 are described above.

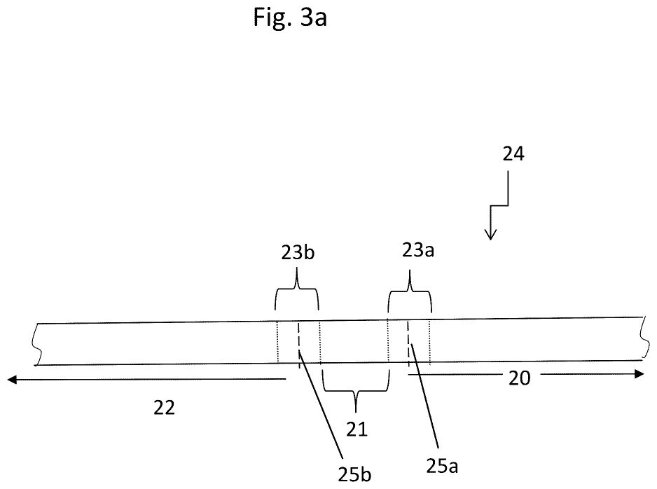

FIG. 3b show a section of a tube 24 with a channel into which a first liquid portion 20, a second liquid portion 21 and a third liquid portion 22 have been fed only a part of the respective first liquid portion 20 and the third liquid portion 22 are shown, whereas the second liquid portion 21 is smaller than the first liquid portion 20 and the third liquid portion 22 and is shown in its entire length of the channel.

The first liquid portion 20 and the second liquid portion 21 forms a first interface 25a where the first liquid portion 20 and the second liquid portion 21 are in interfacial contact. After a contacting time T_{c}, a first interface region 23a comprising the interface 25a is formed.

The second liquid portion 21 and the third liquid portion 22 forms a second interface 25b where the second liquid portion 21 and the third liquid portion 22 are in interfacial contact. After a contacting time T_{c}, a second interface region 23b comprising the interface 25b is formed.

The first liquid portion 20, the second liquid portion 21 and the third liquid portion may be as described above.

In an embodiment, the first liquid portion 20 and the third liquid portion 22 are identical and the second liquid portion 21 differs from the first liquid portion 20 and the third liquid portion 22 with respect to at least one chemical and/or physical property.

In an embodiment, the second liquid portion 21 is a sample liquid to be tested e.g. for presence or concentration of a target element and the first liquid portion 20 and the third liquid portion 22 are test liquids and comprises at least one component that interferes with the target element, e.g. by reacting with the target element, by acting as a denaturant for the target element or interfering any other way.

In an embodiment, the first liquid portion 20 is a buffer comprising a component A, the third liquid portion 22 is a buffer comprising component B and the second liquid portion 21 is a pre mixture of the liquids forming the first liquid portion 20 and the third liquid portion 22, i.e. the second liquid portion 21 is a buffer comprising both component A and component B but is lesser concentrations than the respective first liquid portion 20 and the third liquid portion 22.

A marker may for example be intrinsic or be bound to one of the component A or B.

After the contacting time T_{c} a row of intensity readings of the marker may be performed of respectively a plurality of volume fractions located at the first interface region 23a and the second interface region 23b. If the row of intensity signals show intensity discontinuities relative to a base line, this may indicate a property of one or more of the respective liquid portions as described above.

FIG. 3b illustrates an embodiment where the first liquid portion 20 and the third liquid portion 22 are identical and comprises a buffer comprising a component B and initially no component A, and the second liquid portion 21 is the same buffer comprising component A and initially no component B.

After a contacting time T_{c}, a first interface region 23a and a second interface region 23b are formed where both component A and component B are present. In the middle section 21a of the second liquid portion, component A is in maximum concentration and no component B is present. In the respective furthermost sections 20a and 22a of respectively the first liquid portion 20 and the third liquid portion 22, component B is in maximum concentration and no component A is present.

The estimated average concentration of the component A is illustrated with the dotted line (dot-dash) and the concentration of the component A is illustrated with the dashed line (dash-dash).

### Example 1

An assessment system as shown in FIG. 1 was applied.
A first liquid was prepared to have the following composition:
Hepes buffer 20 mM, pH 7.4.
7.5% peg (Polyethylene glycol)

A second liquid was prepared to have the following composition:
Hepes buffer 20 mM, pH 7.4.
20 nM fluorescent marked dextran (fl-dex)+5% non-marked dextran.

A portion of the first liquid was fed into the channel of the tube 4 as the first liquid portion and a portion of the second liquid was fed into the channel as the second liquid portion followed by a portion of the first liquid that was feed to the channel as a third liquid portion.

The pressure applied for feeding the liquid portions was 375 mbar.

This pressure was maintained for flowing the liquid portions towards the reader arrangement 11 and as the first interfacial region reaches the reader, the reader is performing a plurality of consecutive intensity readings as the interfacial regions are passing through the channel at the reading section.

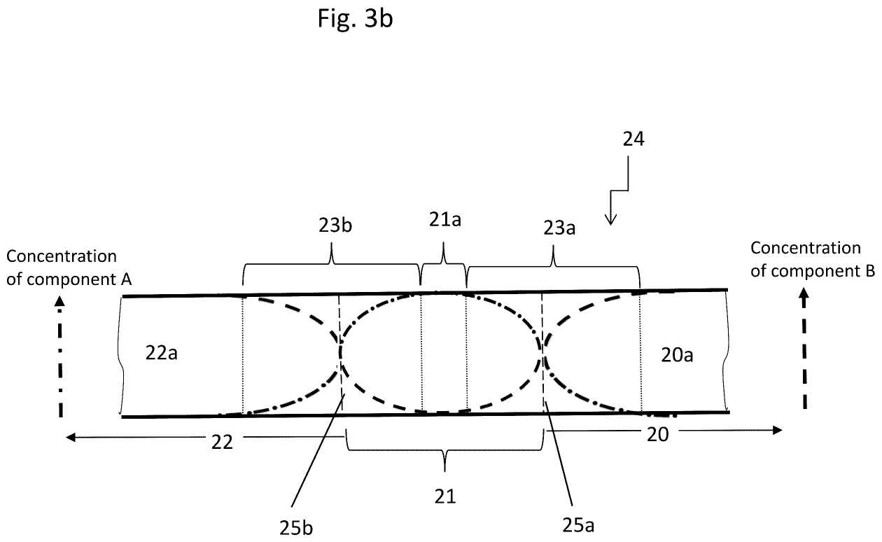

FIG. 4 is a plot of a row of intensity signals obtained.

The line “data start” and “data end” indicates the order of the obtained—i.e. intensity readings closer to the data start line obtained precious to intensity reading further from the data start line and closer to the data end line.

The contacting time T_{c}, may be determined as the travelling time from the time from where both liquid portions were fed to the channel and until the first interfacial region reached the reader arrangement, e.g. the time of the data start line.

The row of intensity signal was obtained within a time frame T_{f} of about 15.5 minutes.

It can be seen that a plurality of intensity spikes are formed in both of the interface regions. A baseline B reaching from about zero to the plateau P and back to about zero is indicated. The intensity signals forming the plateau P is obtained at the second liquid portion and immediately adjacent thereto i.e. between the first and the second interfacial regions. The intensity spikes was interpreted as an indication of a liquid-liquid phase separation in the form of formation of drops as described above.

Examples of other liquid-liquid phase separation that may be examined using as a variation of example 1 are as follows:

| First liquid | Second liquid | solvent |
|---|---|---|
| Dextran in solvent | Peg in solvent | Water |
| Lysozym in solvent | salt (for example NaCl) in | Water |
| | solvent | |
| Lysozyme in solvent | peg in solvent | Water |
| Protein in solvent | oligonucleotide in solvent | Water |
| Antibody in solvent | salt in solvent | Water |

In further variations, the first liquid and the second liquid are switched and/or the solvent is replaced by a buffer.

### Example 2

An assessment system as shown in FIG. 1 was applied.

A first liquid was prepared to have the following composition:
Hepes buffer 20 mM, pH 7.4.
7.5% peg (Polyethylene glycol).

A second liquid was prepared to have the following composition:
Hepes buffer 20 mM, pH 7.4.
20 nM Fluorescein+5% non-marked dextran.

The example was carried out as example 1

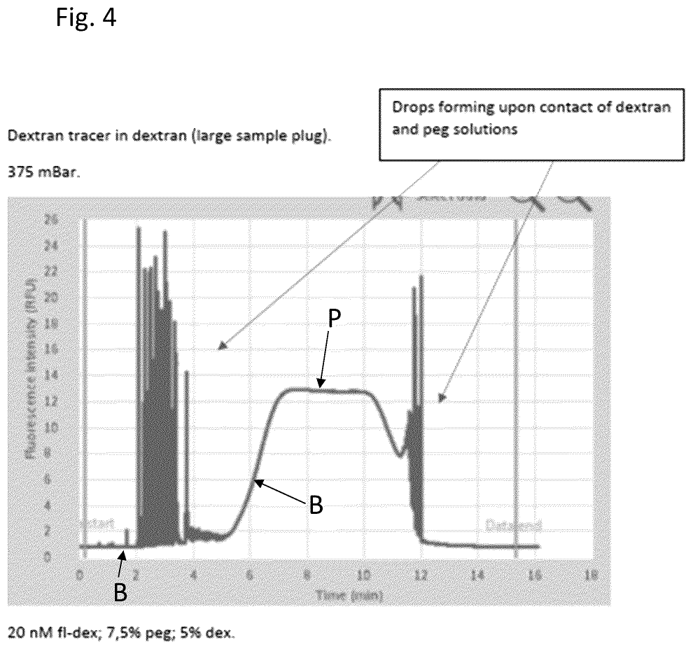

FIG. 5 is a plot of a row of intensity signals obtained.

The row of intensity signal was obtained within a time frame T_{f} of about 20 minutes.

It can be seen that a plurality of intensity spikes are formed in the interface region between the first liquid portion and the second liquid portion.

A row of the intensity signals E2 are enlarged in the cut-out section E1. Here it can be seen that the intensity spikes are substantial deviations from the base line.

Fluorescein is more hydrophobic than dextran and will therefor only to a limited extend distribute to the formed droplets of dextran formed in the first liquid portion.

### Example 3

An assessment system as shown in FIG. 1 was applied.
A first liquid was prepared to have the following composition:
Hepes buffer 20 mM, pH 7.4.
7.5% peg (Polyethylene glycol).

A second liquid was prepared to have the following composition:
Hepes buffer 20 mM, pH 7.4.
20 nM fluorescent marked dextran (fl-dex)+5% non-marked dextran.

A third liquid was prepared to have the following composition:
50% of first liquid.
50% of second liquid.

A portion of the first liquid was fed into the channel of the tube 4 as the first liquid portion and a portion of the third liquid was fed into the channel as the second liquid portion followed by a portion of the second liquid that was feed to the channel as the third liquid portion.

The pressure applied for feeding the liquid portions was 750 mbar.

This pressure was maintained for flowing the liquid portions towards the reader arrangement 11 and as the first interfacial region reaches the reader, the reader is performing a plurality of consecutive intensity readings as the interfacial regions are passing through the channel at the reading section.

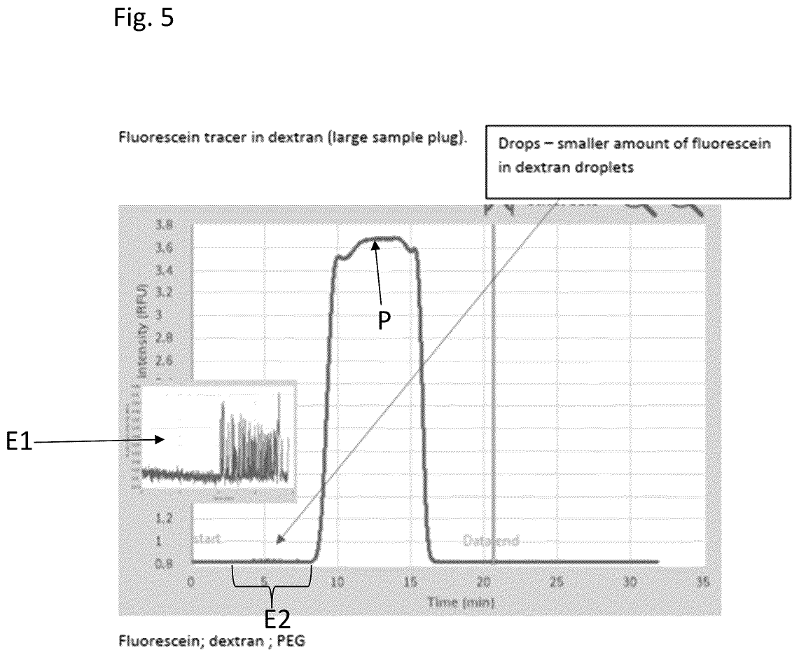

FIG. 6 is a plot of a row of intensity signals obtained.

A row of the intensity signals E2 are enlarged in the cut-out section E1. Here it can be seen that the intensity spikes are substantial deviations from the base line.

It is believed that a mixing has taken place in the continuous phase and that droplets has been formed in a very narrow region as indicated.

### Example 4

This example was carried out as example 3 using a different pressure. The pressure used was 200 mbar.

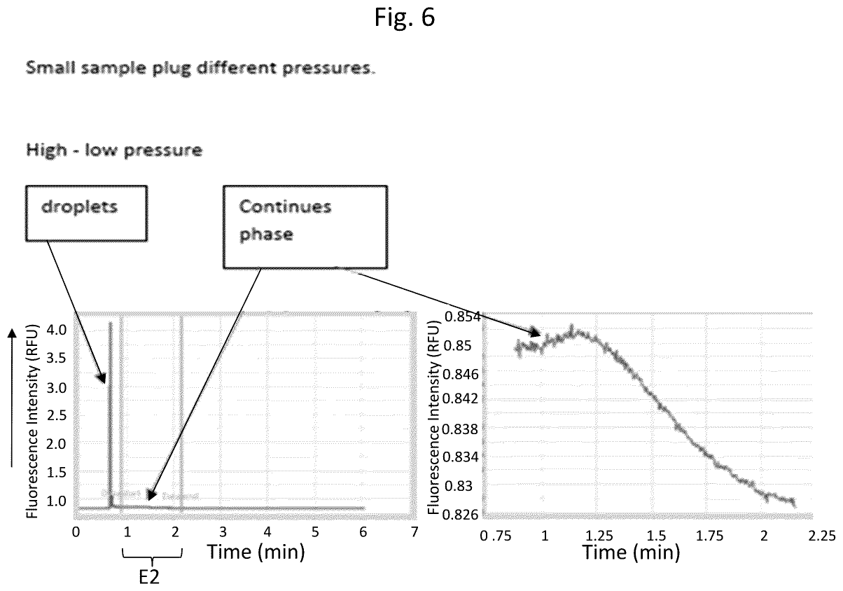

FIG. 7 is a plot of a row of intensity signals obtained.

### Example 5

This example was carried out as example 3 using a different pressure. The pressure used was 100 mbar.

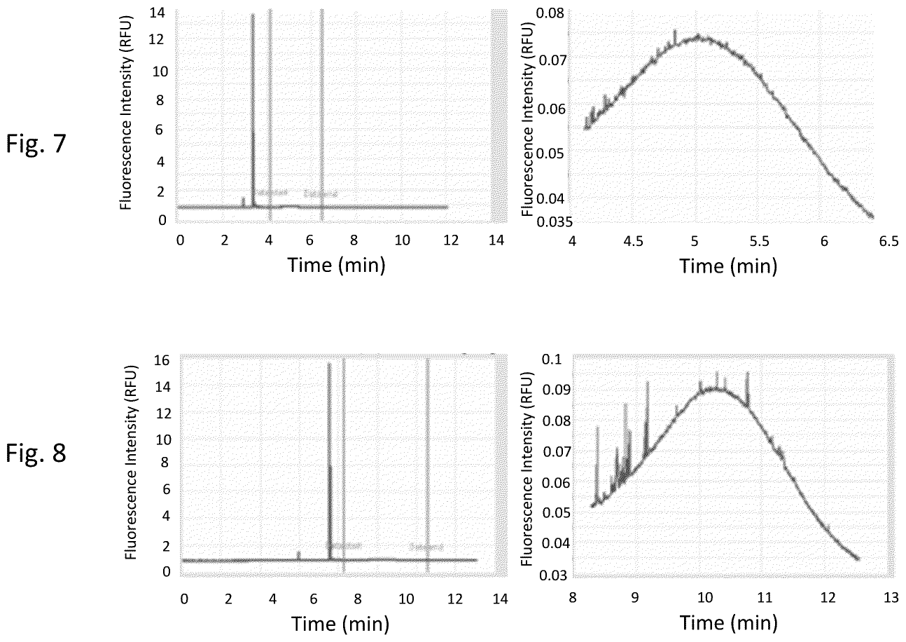

FIG. 8 is a plot of a row of intensity signals obtained.

### Example 5

An assessment system as shown in FIG. 1 was applied.

A first liquid was prepared to have the following composition:
Phosphate buffer, pH 7.4.
7 Denaturant 6M GuHCL

A second liquid was prepared to have the following composition:
Phosphate buffer, pH 7.4.
1 mg/ml BSA (Bovine Serum Albumin)+sypro orange

The example was carried out as example 1.

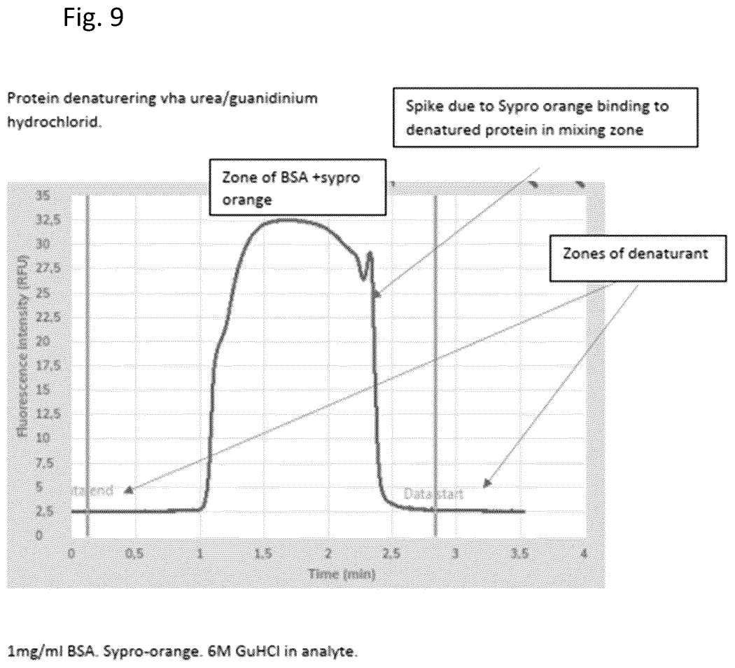

FIG. 9 is a plot of a row of intensity signals obtained.

The row of intensity signal was obtained within a time frame T_{f} of about 3 minutes.

A significant intensity spike can be seen indicating bonding of Spyro orange to denatured protein. This indicates that the BSA is denaturized by the GuHCL and thereafter binding to the Spyro orange.

Such assay may be applied to determine if BSA or another protein is present in a sample and/or the concentration thereof.

### Example 6

An assessment system as shown in FIG. 1 was applied.

A first liquid was prepared to have the following composition:
10 nM fluorescein in phosphate buffer pH 2.3.

A second liquid was prepared to have the following composition:
10 nM fluorescein in phosphate buffer pH 7.4.

The example was carried out as example 1

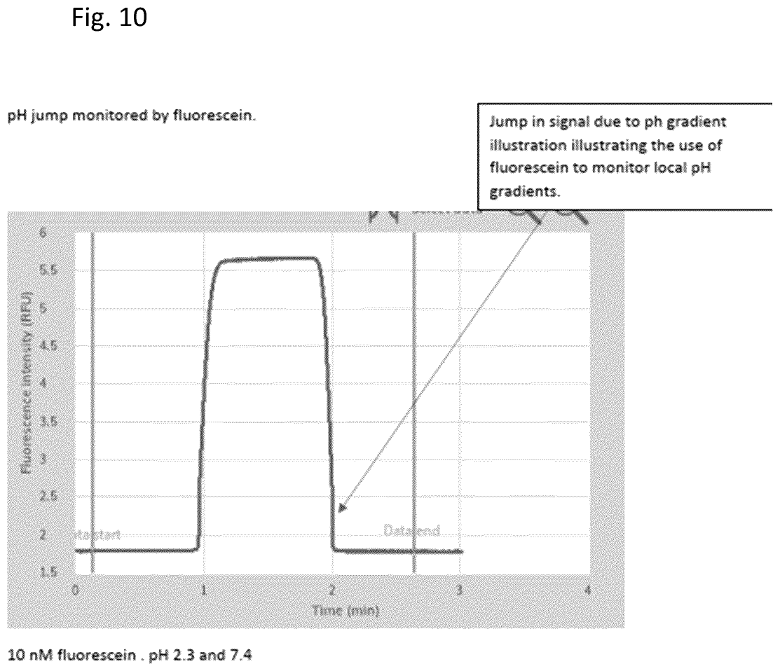

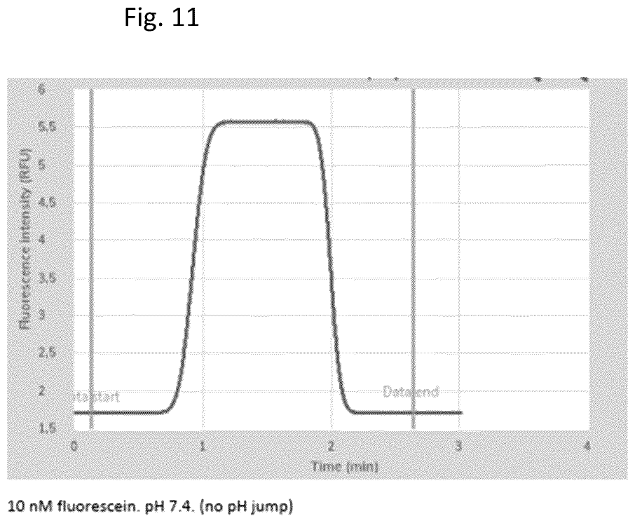

FIG. 10 is a plot of a row of intensity signals obtained.

Fluorescein is pH sensitive and has substantially no emission at pH values in the range 2-4.

It can be seen that there are jumps in signal intensities in bot interface regions from which a pH gradient may be determined.

### Example 7

An assessment system as shown in FIG. 1 was applied.

A first liquid was prepared to have the following composition:
Phosphate buffer pH 7.4.

A second liquid was prepared to have the following composition:
10 nM fluorescein in phosphate buffer pH 7.4

The example was carried out as example 6.

FIG. 10 is a plot of a row of intensity signals obtained.

Here it can be seen that there are no pH jump.

### Example 8

An assessment system as shown in FIG. 1 was applied.

A first liquid was prepared to have the following composition:
200 micromolar BSA in phosphate buffer pH2.3.

A second liquid was prepared to have the following composition:
10 nM fluorescein in phosphate buffer pH 7.4

The example was carried out as example 1, using a pressure of 4000 mbar. The second liquid portions had a volume of 5 μL.

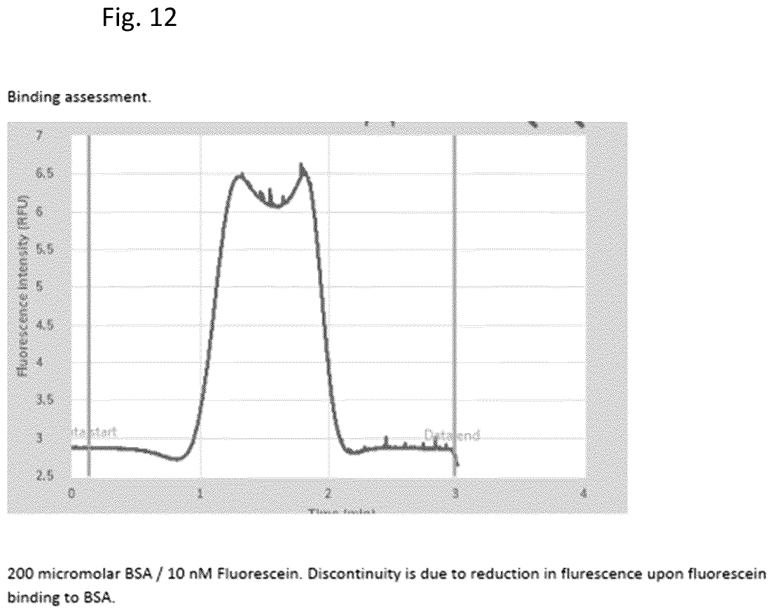

FIG. 12 is a plot of a row of intensity signals obtained.

It can be seen that a number of discontinuities of the signal intensities relative to base line indicating that the fluorescein in local liquid volume fractions binds to BSA.

1. A method for determining a property of at least one liquid, the method comprising
providing at least a first liquid and a second liquid wherein at least one component of the first and/or the second liquid comprises a detectable marker;
feeding liquid into a channel comprising feeding a portion of said first liquid and a portion of the second liquid in succession into a channel to provide an interfacial contact between said first liquid portion and said second liquid portion;
obtaining a row of signals by reading out intensity of said marker of a plurality of volume fractions of said first liquid portion and said second liquid portion located at an interface region comprising said interface between said first liquid portion and said second liquid portion and
determining said property of the at least one of the first liquid and the second liquid from said signal row,
wherein said determination is based on signal perturbations or lack of signal perturbations of the row of signals obtained at the interface region, and
wherein the reading out is performed after a contacting time T_{c} from establishing said interfacial contact between said first liquid portion and said second liquid portion.

2. (canceled)

3. (canceled)

4. The method of claim 1, wherein the signal row comprises a row of intensity readings comprising at least about 10 intensity readings and wherein the signal obtained from the marker is an optical signal in in the form of an intensity of a wavelength range emitted or reflected by the marker or intensity absorbed by the marker.

5. (canceled)

6. (canceled)

7. The method of any claim 1, wherein the determination of said property comprises determination of one or more intensity discontinuities in the form of one or more intensity spikes of the signal obtained from the marker, wherein an intensity spike has a total intensity representing up to 10% of the total intensity of the signal obtained from the marker of said portion of said first liquid and said second portion of said second liquid fed to said channel.

8. (canceled)

9. The method of claim 1, wherein the determination of said property comprises determination of one or more signal perturbations relative to a base line.

10. The method of claim 9, wherein the method comprises determining the baseline by obtaining a baseline row of signals comprising reading out intensity of said marker of a plurality of volume fractions of said first liquid portion and said second liquid portion and generating a best fit continuous curve omitting local peaks.

11-17. (canceled)

18. The method of claim 1, wherein said first liquid and said second liquid differs from each other in at least one chemical and/or physical property.

19. (canceled)

20. The method of claim 1, wherein the first liquid and the second liquid differs from each other in at least one chemical property, selected from
presence/absence at least one element,
concentration of at least one element,
reactivity of at least one element,
stability of at least one element,
pH value,
ionic strength
concentration of dissociated salt, or
a combination comprising one or more of the before mentioned.

21. The method of claim 1, wherein the first liquid and the second liquid differs from each other in at least one physical property, selected from
temperature,
viscosity,
boiling point,
electrical Conductivity,
surface tension, or
a combination comprising one or more of the before mentioned.

22. The method of claim 1, wherein the determination of the property of at least one liquid comprises determining a characteristic property of a liquid-liquid phase interaction and/or reaction of the first liquid and the second liquid from said row of signals.

23. The method of claim 22, wherein the characteristic property comprises a characteristic property of
ability of phase separation,
ability of mixing between the first and the second liquid,
ability of forming a gradient at an interface region between the first and the second liquid,
ability of forming aggregation at an interface region between the first and the second liquid,
ability of reactions between element(s) of the first and the second liquid,
ability of fully or partly degrading,
ability of modifying a structure of an element of the first liquid and the second liquid at an interface region between the first and the second liquid or
any combinations thereof.

24-26. (canceled)

27. The method of claim 1, wherein the determination of the property of at least one liquid comprises determining a chemical property of a sample liquid, provided as one of the first liquid and the second liquid wherein the other of the first liquid and the second liquid is provided as a test liquid for testing the sample liquid,
wherein the determination of the chemical property of the sample liquid comprises determining a chemical property selected from
presence/absence at least one element,
concentration of at least one element,
reactivity of at least one element,
stability of at least one element,
pH value,
ionic strength and/or
a combination comprising one or more of these.

28. (canceled)

29. The method of claim 27, wherein the determination of the chemical property of the sample liquid comprises
determining a chemical property associated to a target element in the sample liquid or to a target element suspected to be present in the sample liquid,
determining reactivity of one or more elements of the sample liquid relative to one or more components of the test liquid or relative to exposure to a pH value at an interface region between the sample liquid and the test liquid,
determining a stability property of a target protein, wherein the test liquid has a different pH value or a higher concentration of one or more selected ions, or
determining a denaturation property or an aggregation property of a target protein, wherein the test liquid has a different pH value than the sample liquid components.

30-32. (canceled)

33. The method of claim 1, wherein at least one of the first liquid and the second liquid comprise a protein; a nucleoside; a nucleic acid or any fragments thereof or any combinations comprising at least one of these.

34. The method of claim 1, wherein at least one of the first liquid and the second liquid comprises natural liquid, biological liquid, protein containing fluid, organic solvent or inorganic solvent.

35. The method of claim 1, wherein at least one of the first liquid and the second liquid comprises a biological liquid obtained from a living organism.

36-51. (canceled)

52. The method of claim 1, wherein the method comprises providing said first liquid portion and said second liquid portion to a flow within said channel, wherein said provision of said first liquid portion and said second liquid portion to flow within said channel comprises, subjecting the liquid portions to a laminar flow for at least about 10 seconds.

53-56. (canceled)

57. The method of claim 1, wherein the reading out of intensity of said marker of a plurality of volume fractions of said first liquid portion and/or said second liquid portion comprises performing intensity readings at at least one reading location of the channel, wherein the reading out comprises performing consecutive readings from different volume fractions of said liquid portions as the respective volume fractions are passing said at least one reading location of said channel.

58. (canceled)

59. The method of claim 52, wherein the method comprise reducing the flow velocity of said liquid portions and/or subjection said liquid portions a temporally flow stop when the read intensity of two or more consecutive readings differs beyond a threshold.

60. (canceled)

61. An assessment system for determining a property of at least one liquid according to the method of claim 1, the system comprising
at least two mother containers for containing at least a first liquid and a second liquid,
a channel,
a reader arrangement for reading out a marker signal from a liquid located in said channel,
a withdrawing and pump arrangement for withdrawing liquid portions from said respective mother containers and for feeding said respective liquid portions in succession into said channel to provide an interfacial contact between said liquid portions, and
a computer system programmed for controlling the elements of the system for carrying out the method of.

62-72. (canceled)

73. The assessment system of claim 61, wherein the assessment system comprises a camera arranged for acquiring images of a liquid located in an image acquisition length section of the channel, wherein said image acquisition length section is located downstream to said at least one reading location, wherein the computer system is programmed for acquiring images of volume fractions which have previously been read at said at least one reading location and wherein the read intensity of two or more consecutive readings differs beyond a threshold.
